(19) United States
(12) Patent Application Publication
(10) Pub. No.: US 2006/0126613 A1
(43) Pub. Date: Jun. 15, 2006

(54) Multi-homed broadband router

(75) Inventor: Jonathan Marcus Zweig, St. Laurent, CA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited

(21) Appl. No.: 11/008,061

(22) Filed: Dec. 9, 2004

(51) Int. Cl. H04J 3/22; H04J 3/16; H04L 12/56; H04L 12/28

(52) U.S. Cl. 370/389; 370/465

(57) ABSTRACT

Described is a multi-homed broadband router for use by an internal network to communicate with an external communications network, such as the Internet. The router has a first external-side port for exchanging packets over a first communication link with a first service provider connected to the external communications network, a second external-side port for exchanging packets over a second communication link with a second service provider connected to the external communications network, and an internal-side port for exchanging packets with a client device connected to the internal network. When a client device attempts to communicate with a host system on the external communications network, the router determines which one of the service providers to use to establish communications between the client device and that host system.

### FIELD OF THE INVENTION

The invention relates generally to data communications. In particular, the present invention relates to multi-homed networks having multiple connections to an external network through a plurality of service providers.

### BACKGROUND

Since its inception, the Internet has grown tremendously. Current estimates indicate that the Internet interconnects millions of host systems around the globe and actively supports hundreds of millions of users. The explosive growth of the Internet, fueled by an increasing number of home networks and business networks, is effectively exhausting the available Internet Protocol (IP) addresses needed to identify uniquely the location of each device connected to the Internet. Separating IP addresses into classes and reserving certain IP addresses for special purposes has contributed to this diminishing availability of IP addresses.

To facilitate efficient use of the available IP addresses, industry has devised Network Address Translation (NAT) so that a single, globally unique IP address, i.e., an Internet-useable address, can represent multiple computing devices connected to a private local area network (LAN). Typically, a service provider assigns the unique IP address to the LAN, whereas each computing device on the LAN receives an assigned private (i.e., not globally unique) IP address. Most packet traffic among computing devices on a LAN remains local to the LAN, and therefore can use these private addresses for exchanging packets. For these computing devices to communicate outside of the LAN, however, a router configured to support NAT operates as a translator between the computing devices and host devices on the Internet. The NAT router maps the private IP addresses of the computing devices to the single, assigned, globally unique IP address.

To perform this translation, the NAT router maintains an address translation table. In brief overview, when a computing device sends a packet to a host system on the Internet, the NAT router replaces the source address of the packet, containing the private IP address of the computing device, with the globally unique IP address before forwarding the packet to the Internet. When the host system on the Internet returns a packet to this computing device on the LAN, the host system uses the globally unique IP address assigned to the LAN as the destination address for the packet. Upon receiving this packet, the NAT router determines that the destination address is present in the address translation table and mapped to the computing device. The NAT router replaces the destination address in the packet with the private IP address of this computing device and forwards the packet to the computing device.

Most home networks and many small business networks have only one connection to the Internet, i.e., through one Internet Service Provide or ISP. Consequently, the availability and quality of a connection to the Internet for such single-homed networks are heavily dependent on the service provider and on the link to that service provider. If the link fails, or if the service provider becomes disconnected from the Internet or experiences routing problems, then the single-homed network loses access to the Internet.

Because Internet connectivity is becoming increasingly crucial to the operation of small businesses and home offices, having multiple connections to the Internet is becoming part of an overall network strategy. Having multiple connections to the Internet reduces the chance of a business shutdown if one of the connections were to fail. Local area networks and small office/home office (SOHO) networks with multiple connections, referred to as multi-homed networks, may connect to multiple different ISPs to reach the Internet. However, many current multi-homed networks do not capitalize fully on this redundancy because each computing device on a LAN is typically connected to the Internet through only one of the service providers. Consequently, to respond to a loss of access to the Internet through this one service provider, an administrator often needs to intervene to switch the affected computing devices to another service provider. The switchover process can be complicated and time consuming, and therefore may not even occur: it may be faster and simpler to wait for the service provider to remedy the problem affecting Internet access rather than make any changes to the affected computing devices on the LAN.

### SUMMARY

In one aspect, the invention features a multi-homed router comprising a first external-side port for exchanging packets over a first communication link with a first service provider connected to an communications network, a second external-side port for exchanging packets over a second communication link with a second service provider connected to the communications network, and an internal-side port for exchanging packets with a client device connected to an internal network. The router also has means for determining which one of the service providers to use when establishing communications between the client device and a host system connected to the communications network.

In another aspect, the invention features an internal network comprising a client device and a router. The client device transmits a packet targeted to a host system on an external communications network. The router has an internal-side port by which to receive the packet from the client device, a first external-side port by which to communicate with a first service provider in order to access the external communications network, and a second external-side port by which to communicate with a second service provider in order to access the external communications network. The router has means for determining which one of the service providers to use in order to establish communications between the client device and the host system on the external communications network.

In still another aspect, the invention features a method for exchanging packets between an internal network and an external communications network. A first communication link is established with a first service provider connected to the external communications network, and a second communication link is established with a second service provider connected to the external communications network. A packet targeted to a host system on the external communications network is received from a client device on the internal network. One of the first and second service providers is determined for use in establishing communications between the client device and the host system on the external communications network.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a schematic representation of an embodiment of a communications network in which a router within an internal network routes packet traffic between a plurality of service providers on an external network and client devices on the internal network in accordance with the principles of the invention.

FIG. 2 is a diagram of an embodiment of a plurality of address translation tables for use by the router of FIG. 1 when forwarding a received IP packet to one of the plurality of service providers.

FIG. 3 is a block diagram of an embodiment of the router of FIG. 1 configured for network address translation for sending communications from the client devices to host systems on the external network through the plurality of service providers.

FIG. 4 is flow diagram of an embodiment of a process for sending packets from a client device on an internal network to a host device on an external network through one of the plurality of service providers.

FIG. 5 is a block diagram of an embodiment of the router of FIG. 1 configured for network address translation for handling communications received from host systems on the external network through the plurality of service providers and intended for client devices on the internal network.

FIG. 6 is a flow diagram of an embodiment of a process for handling packets received from a host device on an external network through one of the plurality of service providers and intended for a client device on the internal network.

### DETAILED DESCRIPTION

The present invention features a broadband router (or firewall unit) for use in an internal network and capable of communicating concurrently with more than one service provider. Each service provider enables access to an external communications network, e.g., the Internet. The service providers share support of data traffic exchanged between the internal network and the external communications network, thus providing a higher combined bandwidth and increasing service reliability by supporting failover.

In brief overview, one embodiment of the router provides network address translation (NAT) services. Each service provider assigns a different globally unique IP address to the internal network. For any new address translation task, the router dynamically maps one of the local IP addresses assigned to the client devices on the internal network to one of the plurality of different service-provider IP addresses. This mapping made by the router is based on a single criterion or combination of criteria, such as failover and load balancing considerations. Another consideration in the selection of a particular service provider is cost-minimization: the router can map connections between a client device on the internal network to provider-side addresses such that the cost of links is minimized. The router may also employ quality of service considerations to place important data traffic onto more expensive service provider links and less important traffic onto a lower-cost, lower-performance service provider. To collect information for making the service-provider selection, the router monitors the status of each service provider based on the availability of the communication link to that service provider and, optionally, upon the availability or performance of external network resources.

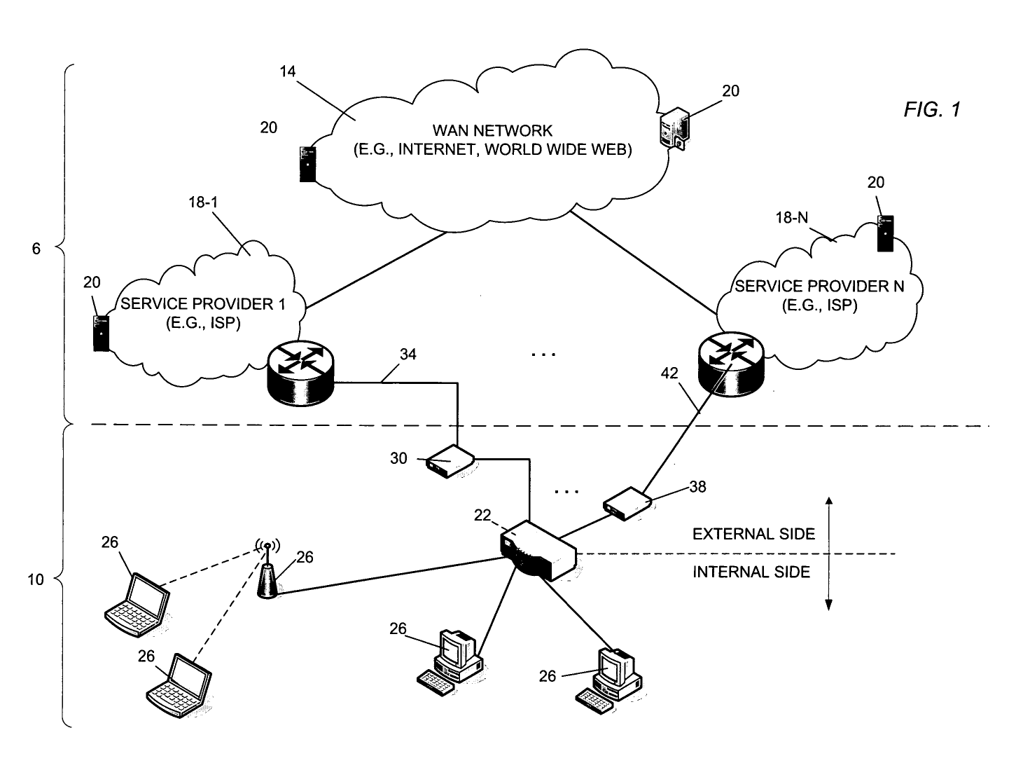

FIG. 1 shows an oversimplified example of a communications network 2 including an external network 6 in communication with an internal network 10 embodying the present invention. In the example shown, the external network 6 includes a wide area network (WAN) 14 and a plurality of service providers 18-1, 18-N (generally, service provider 18) for providing access to various host systems 20 on the WAN 14. In general, the host systems 20 are any computing device connected to the WAN 14 and assigned a globally unique IP address. Examples of host systems 20 include email servers, file servers, directory servers, application servers, and Web servers. The Internet and the World Wide Web are exemplary embodiments of the WAN 14. Although shown as separate from the WAN 14, the networks of the service providers 18 can be considered as part of the WAN 14 without departing from the principles of the invention. Further, although also shown as being connected to the same WAN 14, the service providers 18 can, in other embodiments, connect instead to different networks, e.g., one service provider connects to an intranet while another service provider connects to the Internet, or the service providers 18 can have differing capabilities for reaching host systems 20 on the WAN 14, i.e., parts of the Internet are unreachable by one service provider and reachable by another.

Service providers 18 can include Internet Service Providers (ISPs) and online services, such as America Online. For a monthly connection fee, ISPs generally enable their customers to access to the WAN 14 for such purposes, for example, as visiting web sites and exchanging email messages with remote host systems. Online services, in comparison, in addition to providing Internet access, also often offer their subscribers access to special host systems, unique content, and other services. For these online services, subscribers typically pay a monthly subscription fee. ISPs and online service organization can also charge fees for accessing certain services, content, or areas on a usage basis.

The internal network 10 includes a router 22, constructed in accordance with the principles of the invention, and a plurality of client devices 26 in wired or wireless communication with the router 22. Example embodiments of the internal network 10 include private networks, small office/home office (SOHO) networks, and local area networks (i.e., LANs). Examples of client devices 26 on the internal network 10 include, but are not limited to, computer systems (e.g., desktop and laptop), wireless access points, printers, file servers, multimedia servers, imaging devices (e.g., scanners, web-cams), and home stereo equipment (e.g., TiVo®).

In the embodiment shown, the router 22 is in communication with the plurality of service providers 18, although the principles of the invention can scale to more than two service providers. The router 22 has an external side (with external-side or WAN ports) and an internal side (with internal-side or LAN ports). On the external side, the router 22 is in communication with a first service provider 18-1 through a first modem 30 over a first communication link 34 and with a second service provider 18-N through a second modem 38 over a second communication link 42. In one embodiment, the modems 30, 38 establish continuous connections between the router 22 and the respective service providers. In other embodiments, one or both of the modems 30, 38 establish connections on demand, e.g., using an analog dialup modem connection or a satellite connection. In general, the communication links 34, 42 carry broadband signals (i.e., multiple signals sharing the bandwidth of a single medium). Preferably, the external-side communication links 34, 42 use different physical media to connect the modems 30, 38 to their respective service providers 18. For example, the first modem 30 can be a cable modem; the first communication link 34, a cable line; the second modem 38, a digital subscriber line (DSL) modem; and the second communication link 42, a digital subscriber line (e.g., DSL, ADSL). As additional examples, communication links can be telephone lines and satellite links.

For links of different physical media, in general, the probability of an outage on one link is statistically independent of the probability of an outage on the other link. Thus, the probability of simultaneous outages of the external-side links is the product of the individual outage probabilities. For example, if a DSL link and a cable modem link are each available for carrying services 99.9% of the time (i.e., less than 9 hours/year downtime), together the links should be able to support the services with less than a minute of downtime per year. Thus, connecting the internal network 10 to the external network 6 by more than one service provider improves service reliability.

Communications exchanged among the client devices 26 and between the external and internal networks 6, 10 use IP addresses to identify the locations of the various client devices and host systems. IPv4 and IPv6 versions of IP addresses can be used to practice the invention. Although described herein primarily with respect to IP addresses and IP packets, the invention can also be practiced using non-IP protocols, non-IP addresses, and non-IP packets or datagrams. Within the internal network 10, client devices 26 communicate with each other using local IP addresses. Local IP addresses are private to the internal network 10 (i.e., unique and known within the internal network only). In one embodiment, the router 22 is DHCP-enabled (Dynamic Host Configuration Protocol). As a DHCP-server, the router 22 centrally manages and automates the assignment and distribution of the local IP addresses to the various client devices 26 of the internal network 10. In another embodiment, an administrator of the internal network 10 records each local IP address manually at each client device 26.

To enable client devices 26 to communicate outside of the internal network 10 (e.g., with host systems on the WAN 14), each service provider 18 allocates at least one globally unique IP address to the internal network 10. Such addresses are referred to as WAN IP addresses. (As used herein, “WAN IP addresses” are not limited to the particular IP addresses assigned to the internal network 10, but also refer to globally unique IP addresses associated with the host systems 20 of the various service providers 18 and with the various host systems 20 that are part of the WAN 14). Some ISPs assign a different “dynamic” WAN IP address to the internal network 10 each time a customer connects to the ISP (i.e., logs on). Other ISPs can assign a fixed static WAN IP address.

In one embodiment, the router 22 is configured to perform network address translation (NAT) between the multiple local IP addresses of the client devices 26 to the WAN IP addresses assigned to the internal network 10 (i.e., at least one WAN IP address being assigned by each service provider 18). Accordingly, the router 22 maintains an M-to-N mapping between local IP addresses and WAN IP addresses, where M is an integer value greater than zero and N is an integer value greater than one. When M is equal to 1, one client device 26 on the internal network 10 is able to load-share across more than one service provider connection.

The particular network address translation employed by the router 22 can have different forms including static NAT, dynamic NAT, overloading, and “inverse overloading.” For static NAT, the router 22 maintains an address translation table that performs one-to-one mapping of local IP addresses to WAN IP addresses. This form is particularly useful when a local device needs to be accessible outside of the local network. Dynamic NAT involves mapping an local IP address to a WAN IP address from a group of WAN IP addresses (typically, the first available WAN IP address). For overloading, the router 22 maps multiple local IP addresses to a single WAN IP address by using different ports. For inverse overloading, multiple WAN IP addresses (i.e., the WAN IP addresses assigned to the internal network by the plurality of service providers 18) can map to a single local IP address. Like overloading, inverse overloading uses ports as part of the mapping. Although the invention can apply to any of these forms of NAT, this description refers primarily to the form of inverse overloading to illustrate the invention.

Communication among the client devices 26 on the internal network 10 and with the host systems 20 on the external network 6 (through the router 22) are in the form of IP packets. The client devices 26 and router 22 can exchange IP packets with the external network 6 using one or more different communication protocols. Such communication protocols include TCP/IP (Transmission Control Protocol/Internet Protocol). When transmitting data, the TCP breaks the data into packets, and the device or host system receiving the packets reassembles the data. IP routes the IP packets through the network. Another such communication protocol is the UDP (User Datagram Protocol). UDP is a connectionless transport layer protocol that exchanges datagrams (i.e., packetized data) without acknowledgements and guaranteed delivery. Like TCP, UDP runs atop IP (UDP/IP), but, unlike TCP, does not break up a message into sequenced packets, nor reassemble packets at the receiving end. Because UDP does not perform error processing and retransmission, UDP can produce an uninterrupted file transfer, which is particularly advantageous for streaming data. Other protocols that run on top of IP and are applicable for practicing the invention include, but are not limited to, ICMP (Internet Control Message Protocol), IGMP (Internet Group Multicast Protocol), EGP (Exterior Gateway Protocol), MTP (Multicast Transport Protocol), and various IPv6 routing protocols.

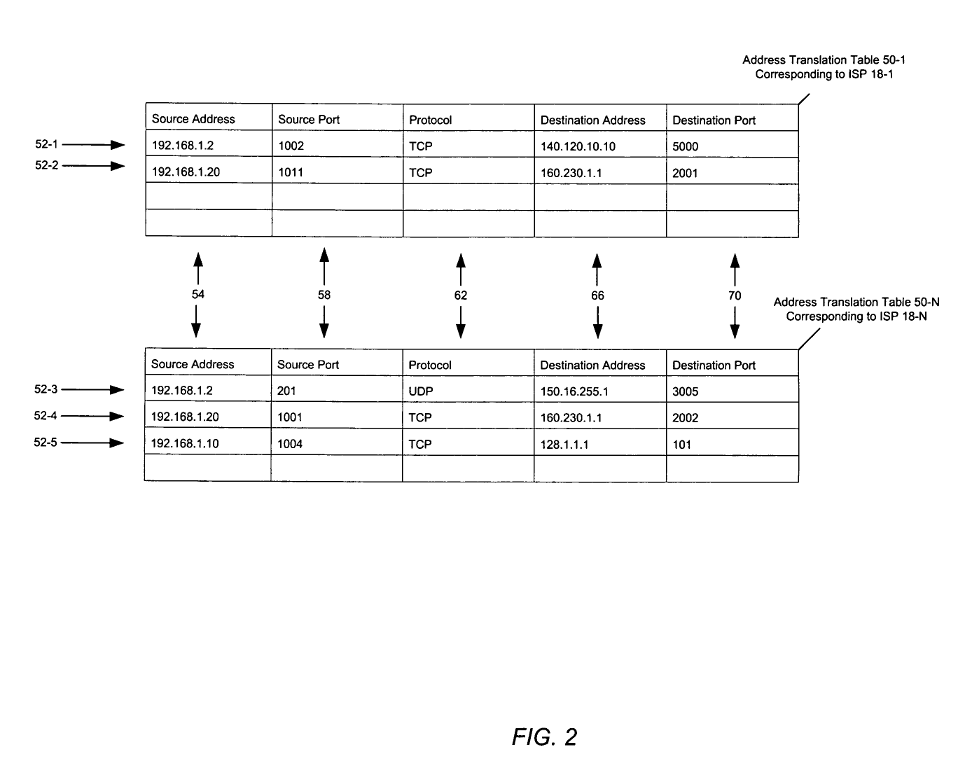

In accordance with the particular protocol used, each IP packet exchanged between the internal and external networks 10, 6 includes header information such as a source IP address, a source port number, a destination IP address, and a destination port number. As shown in FIG. 2, the router 22 includes a plurality of address translation tables 50-1, 50-N (generally, address translation table 50), one address translation table for each service provider 18 with which the router 22 is in communication. Although multiple address translation tables 50 are shown, it is to be understood that a single address translation table can maintain the connections established between the client devices 26 and host systems 20 without departing from the principles of the invention.

Each address translation table 50 can have one or more entries 52-1, 52-2, 52-3, 52-4, and 52-5 (generally, 52). Each entry 52 represents a process or “connection” between a client device 26 and a host system 20 on the external network 6. As used herein, a connection applies to connection-oriented and connectionless communications between a client device 26 and a host system 20. Each entry 52 (hereafter, connection 52) has a plurality of fields, including a source address field 54, a source port number field 58, a field 62 for identifying of the protocol used for the connection, a destination address field 66, and a destination port number field 70. The source address field 54 identifies the client device 26 seeking and potentially establishing a connection to a host system 20 on the external network 6. The dot-notation value in this field represents the local IP address assigned to that client device 26 during the configuration of the internal network 10. The destination address field 66 identifies the desired external recipient (i.e., host system 20) of the communications and holds a WAN IP address associated with that host system. The router 22 may configured to communicate with a Domain Name Server (DNS) to obtain this WAN IP address from an alphanumeric domain name given to the router 22 by the source client device 26.

When the router 22 is configured for inverse overloading, the source client device 26 also includes source and destination port numbers 58, 70. The combination (i.e., tuple) of the source and destination IP addresses 54, 66, source and destination port numbers 58, 70, and protocol identifier 62 defines a single connection 52. Tuples are also used for demultiplexing communications received from the external network 6 and intended for client devices 26 on the internal network 10.

Any given client device 26 on the internal network 10 can engage in multiple, active concurrent connections with the same internal or external host system or with different remote host systems 20 using different TCP or UDP ports. These concurrent connections can appear in the same address translation table or in different address translation tables, depending upon whether the concurrent connections use the same or different service providers. When there are concurrent connections listed in different address translation tables 50, this indicates that the client device 26 has established different connections through different service providers 18. These concurrent connections can be to the same host system or to different host systems 20, as illustrated by the following two examples shown in FIG. 2:

As an example of different connections through different service providers to different host systems, the client device 26 identified by local IP address 192.168.1.2 has a TCP connection 52-1 with a first host device identified by WAN IP address 140.120.10.10 and a UDP connection 52-3 with a different host device identified by WAN IP address 150.16.255.1. The TCP connection 52-1 uses one service provider 18-1, and the UDP connection 52-3 uses another service provider 18-N.

As an example of different connections through different service providers to the same host system, the client device 26 identified by local IP address 192.168.1.20 has a first TCP connection 52-2 using destination port 2001 with a host device identified by WAN IP address 160.230.1.1 and a second TCP connection 52-4 with this same host device using destination port 2002. Here, the TCP connections 52-2, 52-4 are between the same client device and the same host device using different service providers 18-1, 18-N.

Populating the address translation tables 50 with entries 52 occurs when one or more of the client devices 26 on the internal network 10 attempts to communicate with the host systems, e.g., a Web server, on the external network 6. The router 22 receives an IP packet from a client device 26 and examines the packet header information. From the packet header, the router 22 obtains the source address, source port number, destination IP address, and destination port number for populating a new entry 52. Other techniques for populating the address translation tables can supplement or be used alternatively to this technique, without departing from the principles of the invention. For example, in some implementations, incoming requests from the external network 6 are permitted. These requests often specify a “DMZ” client device to which all unsolicited connection requests or UDP traffic is forwarded. In such implementations, the address translation table can have a static “default” entry for directing unsolicited traffic from the external network to this DMZ client device.

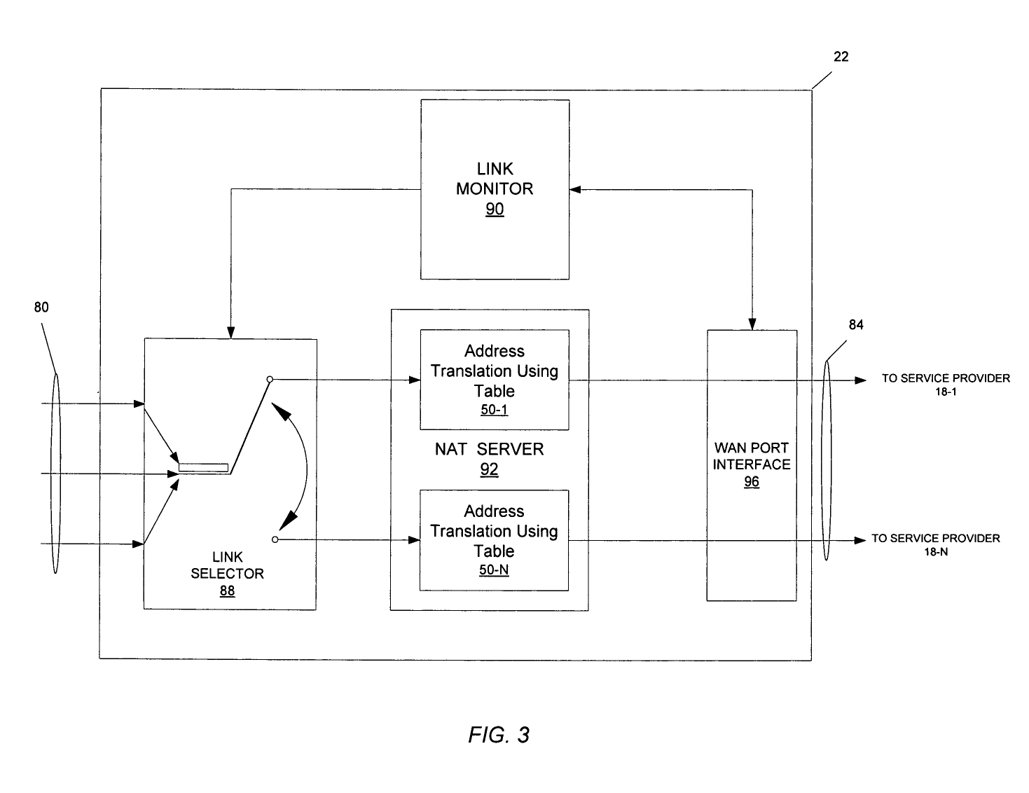

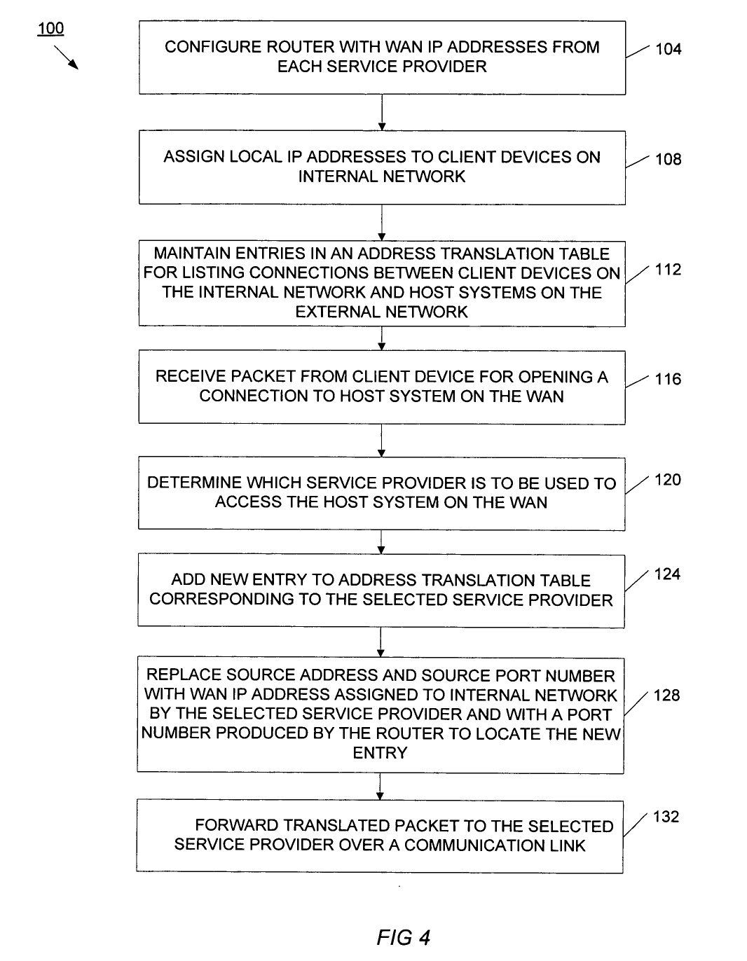

In conjunction with generating the new entry 52, the router 22 replaces the local IP address of the client device 26 in the header of the packet with a selected WAN IP address of the router 22. As described above, each service provider 18 assigns a WAN IP address to the internal network 10. In accordance with the principles of the invention, the router 20 selects one of these WAN IP addresses for inclusion in the IP packet. Processes for determining which service provider 18 to use in order to access the external network 6, i.e., to which address translation table 50 to add the new connection, are described below in connection with FIGS. 3 and 4. The router 22 also replaces the source port number with a port number that identifies a location in the address translation tables 50 at which the source and destination address and port information for the new connection 52 are stored. The address translation tables 50 thus have a mapping between the local IP address and port number of the source client device 26 and the selected WAN IP address of the router 22.

When an IP packet arrives from the external network 6, the router 22 examines and uses the destination port number in the IP packet to access information corresponding to the connection 52 corresponding stored at that location in the address translation table 50 associated with that WAN interface. Provided the destination port number corresponds to a valid location in the address translation table, the router 22 replaces the destination address and destination port number in the packet with the source address and source port number corresponding to that connection 52. The router 22 then forwards the IP packet over the internal network 10 to that client device 26. When a valid location is not present in the address translation tables 50, the router 22 may drop the IP packet, thus serving as a type of firewall protecting the client devices 26 on the internal network 10 from unsolicited packet traffic.

FIG. 3 shows a functional block diagram of an embodiment of the router 22 including a plurality of LAN ports 80 for connecting to the client devices 26 on the internal network 10 and a plurality of WAN ports 84 for connecting to broadband modems 30 and 38. In one embodiment, the LAN and WAN ports 80, 84 use RJ45 connectors for receiving Ethernet cables. The router 22 also includes a link selector 88, a link monitor 90, a network address translator (NAT) server 92 having the address translation tables 50 of FIG. 2, and a WAN port interface 96. The WAN port interface 96 includes hardware, software, or both for transmitting and receiving packets to and from each type of modem device used by the router 22 to communicate with a service provider 18.

The link selector 88 includes hardware, software, or both for determining which one of the service providers 18 is to be used when a client device 26 requests a new open connection to a host system 20 on the external network 6. In general, any one of the service providers 18 can provide access to this host system 20, whereas the link selector 88 chooses a preferred service provider (for this connection) based on a certain criterion or criteria. Any one or combination of the link selector 88, link monitor 90, and WAN port interface 96 can evaluate the criterion or criteria upon which the link selector 88 bases the selection. A user of a client device 26 may be unaware of any selection process or of which service provider the link selector 88 chooses to handle the connection.

The link selector 88 can use any one or combination of the following criteria to select a service provider for use in handling a new connection. On type of criterion is load balancing. Balancing the workload across the various service providers operates to increase service performance. As one simple example of load balancing, whenever the router 22 receives a request for a new connection from one of the client devices 26, the link selector 88 can alternate between two address translation tables 50, or if there are more than two address translation tables, select a service provider on a round-robin basis. As another form of load balancing, the link selector 88 can base the selection of the service provider on the current number of active connections 52 involving each service provider. For example, if one address translation table has two connections 52 and another address translation table has three connections 52, then the link selector 88 directs the next new connection to the address translation table with the fewer connections.

As another example of a load-balancing criterion, if one service provider is presently performing a bandwidth-intensive transaction for the internal network 10, while another service provider is idle or performing less intensive transactions, the link selector 88 can select the less busy service provider. For example, if one client device 26 has presently initiated a file transfer transaction using a first service provider, the link selector 88 can direct a subsequent new connection (from the same or different client device) to a different service provider while the file transfer occupies the first service provider. As another example, the bandwidth capacity of the communication links to the service providers 18 is another criterion that the link selector 88 can use to determine which service provider to use. Higher-bandwidth communication links can be used to carry bandwidth intensive communications (e.g., graphics, video data), while lower-bandwidth communication links can support less time-critical transactions, such as file transfers and emails. Bandwidth utilization is still another load-balancing criterion that can be used to affect the selection: for example, the link selector 88 can choose the service provider with low-percentage utilization (even if it has the lesser bandwidth capacity) over a service provider for which most or all of its bandwidth is utilized.

Another type of criterion is performance-related. For example, the link monitor 90 can learn that one service provider provides optimal performance for accessing a particular Web site on the external network 6 (e.g., Google) than each of the other service providers, and that a second service provider is best for accessing a different particular Web site (e.g., cnn.com). The link selector 88 can thus choose which address translation table 50 to hold the new connection based on the domain name (i.e., destination IP address) identified in the IP packet from the requesting client device 26.

Another performance-based criterion is whether one of the links (e.g., 34, 42 of FIG. 1) to a service provider 18 is down (i.e., failed) or if the service performance provided by the service provider has degraded to an unacceptable level. In some embodiments, the functionality of the link monitor 90, WAN port interface 96, or both includes the capability of detecting a failed link or degraded service performance and of communicating the failed or degraded status to the link selector 88. Details for detecting a failed link and degraded service performance are described in U.S. patent application Ser. No. 09/751,333, filed Dec. 28, 2000, titled “System, Apparatus, and Method for Notifying Wireless Units of Access Point-to-Network Failure in a Wireless Network,” the entire contents of which are incorporated by reference herein. While the failed link remains down or service performance remains degraded, the link selector 88 directs any requests for new connections from the client devices 26 to another service provider with which the router 22 has a currently operable communications link and an acceptable service performance level. Thus, a user who is seeking access to the WAN 14 by way of a new connection does not need to become aware of the failed link or degraded service provider. With respect to those connections that are currently using a failed communication link or degraded service provider, the router 22 can “switch over” these connections to another service provider after notifying the user that the connections have failed and prompting the user to reestablish communications. To achieve the switch over, the router 22, in effect, removes each failed connection from the address translation table 50 associated with the inaccessible or degraded service provider and adds new connections to each address translation table 50 associated with a reachable and acceptable service provider.

When a communication link fails, the router 22 can also be programmed to contact automatically the service provider of the failed communication link through another still-operable communication link (i.e., through another service provider). Thus, not only can the user remain unaware of the failed communication link, but also corrective action can commence without the user's knowledge or intervention. Further, the router 22 can proactively send packets to each client device 26 on the internal network 10 affected by the failed communication link. Consequently, failed connections can be closed rather than having to rely on the host systems 20 on the external network 6 to time out or detect a failed connection.

Latency can be another criterion upon which to base the selection of a service provider. For example, when one of the client devices attempts to open a new connection, the WAN port interface 96 can send duplicate requests to each of the service providers 18 using each corresponding address translation table 50. Whichever service provider produces the fastest response, the link selector 88 selects the address translation table 50 and communication link associated with that service provider.

As an example of a process for comparing the performances of the service providers, consider that one of the client devices 26 on the internal network 10 establishes a plurality of concurrent connections with a particular host system on the WAN 14. One of the connections passes through a first service provider 18-1 and the other connection passes through a second service provider 18-N. The particular host system is chosen for this process because of its particular behavior: for instance, the host system periodically transmits discrete, independent pieces of information, such as an updated stock quote, to each open connection. Thus, the host system treats the different connections as two different client devices, although they are in fact the same client device communicating with the host system by way of two different service providers. The link monitor 90, WAN port interface 96, or a combination thereof can compare the times of arrival or duration of transmission of the updated data and determine which of the service providers has the lesser latency. The link selector 88 can use this determination to select which service provider to use for the next new connection.

Examples of other criteria upon which the selection of the service provider can be based include security, cost, quality of service, the type or class of data (e.g., video, text), robustness (e.g., failure frequency), and jitteriness (e.g., error frequency). With respect to security, the link selector 88 can direct packet communications requiring a secure connection to a particular service provider, whereas other packet traffic passes to another service provider. Concerning cost, if one or more of the service providers (such as satellite ISPs) charge fees on a usage basis, the link selector 88 can direct connections away from communication links to those service providers that have such fees, except under certain predefined circumstances. Other criteria for making this determination can also be used without departing from the principles of the invention. Gathering performance information, measuring robustness and jitteriness, detecting link failure, comparing latencies, and maintaining information regarding bandwidth utilization, bandwidth capacity, security, and cost are various functions that can be designed into the link monitor 90, WAN port interface 96, or a combination thereof.

FIG. 4 shows an embodiment of a process 100 for providing multi-homed connections with the external network 6. At step 104, the router 22 is configured with the WAN IP addresses provided by each service provider in communication with the router through a communication link. Also, the router 22 assigns (step 108) a local IP address to each of the client devices 26 on the internal network 10. The router 22 maintains (step 112) multiple separate sets of entries in an address translation table. Note, this example uses only one address translation table, and uses different sets of entries to distinguish between or among the service providers. Each set of entries corresponds to a different one of the service providers and lists those connections between the client devices 26 on the internal network 10 and host systems on the external network 6 through that particular service provider. As an alternative to using different sets of entries, the address translation table can have an additional field that identifies for each connection the particular service provider used for that connection.

At step 116, the router 22 receives a packet from one of the client devices 26 seeking to initiate communication with a first host system on the Internet. Based on certain criterion, such as described above, the router 22 determines (step 120) which of the service providers to use to service the request. Based on this selection, the router 22 adds (step 124) a new entry to the appropriate entry set corresponding to the selected service provider. The new entry includes the source and destination addresses and source and port numbers extracted from the received packet, and the identity of the protocol used in the connection. The router 22 replaces (step 128) the source address with the WAN IP address assigned to the internal network 10 by the selected service provider and the source port number with a new port number derived by the router 22 to identify the location in the address translation table of the new entry. The router 22 then forwards (step 132) the “translated” packet to that selected service provider over a communication link.

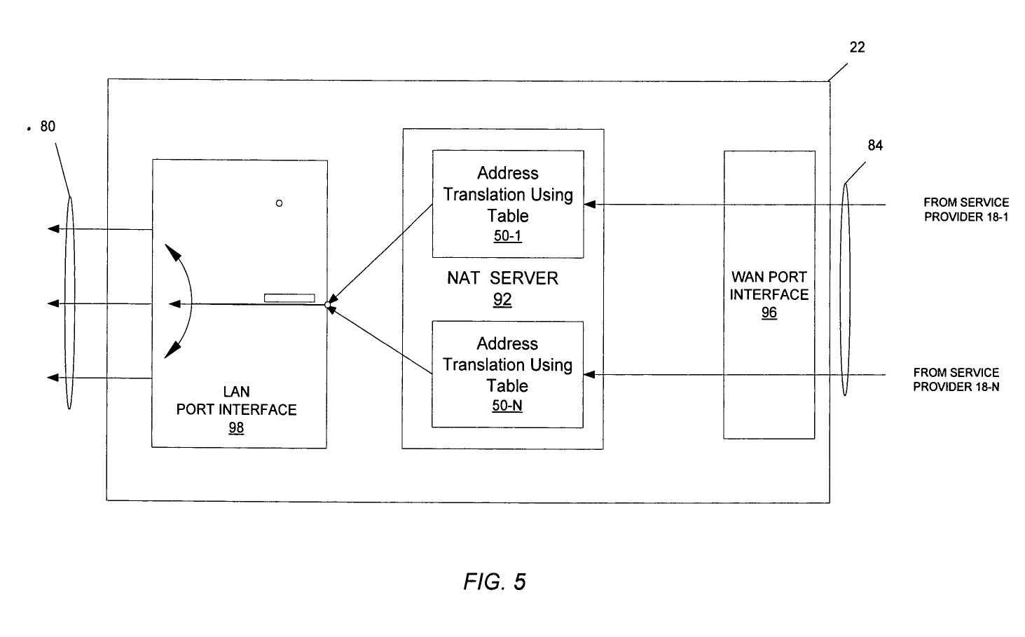

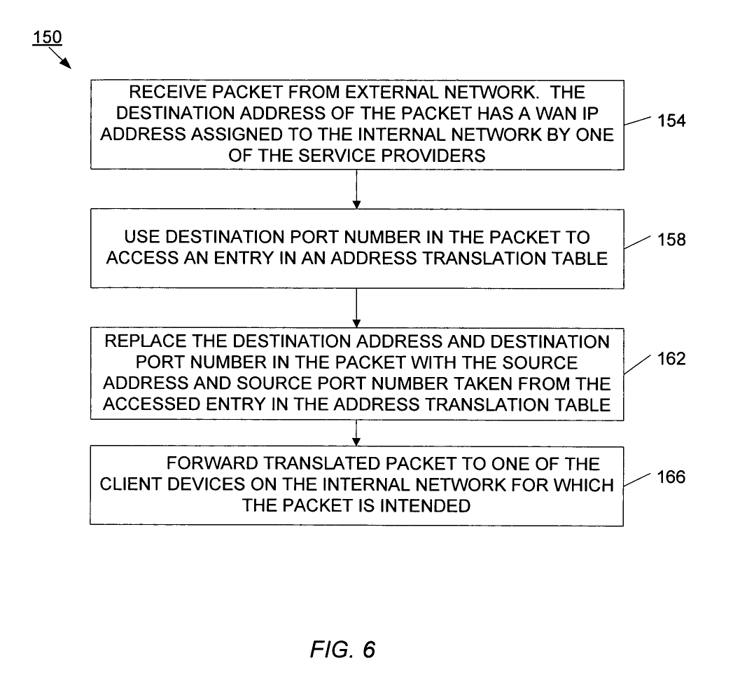

FIG. 5 shows another functional block diagram of an embodiment of the router 22, here illustrating a flow of packet traffic from host systems 20 on the external network 6 to client devices 26 on the internal network 10. The router 22 includes the NAT server 92 and the WAN port interface 96 described above in connection with FIG. 3 and a LAN port interface 98. FIG. 6 shows an embodiment of a process 150 for handling communications received from the external network 6 intended for one of the client devices 26 on the internal network 10. In the description of the process, reference is made also elements of FIG. 5. At step 154, the router 22 receives a packet from a host system on the external network 6 through one of the service providers 18. The packet arrives at the WAN port interface 96 through one of the WAN ports 84. The destination address in the header of the packet identifies the WAN IP address assigned to the internal network 10 by that service provider 18. At step 158, the router 22 uses the destination port number in the packet header to locate and access an entry in one of the address translation tables 50.

Then, the router 22 replaces (step 158) the destination address and the destination port number in the packet header with the source address and the source port number taken from the accessed entry. This source address corresponds to the local IP address of the client device 26 for which the packet is intended. The source port number is the port number assigned by this client device 26 for communicating with this host system on the external network 10. The router 22 then forwards (step 162) the “translated” packet to the client device 26 over the appropriate LAN port 80 through the LAN port interface 98.

While the invention has been shown and described with reference to specific preferred embodiments, it should be understood by those skilled in the art that various changes in form and detail may be made therein without departing the spirit and scope of the invention as defined by the following claims. For example, other embodiments can use more than two address translation tables to implement the NAT translation, and have fewer, more, or different types of fields for each entry in an address table than those described. As another example, although routers embodying the invention are described herein as performing network address translation between local IP addresses and WAN IP addresses, the principles of the invention can also apply to broadband routers that do not perform NAT. More specifically, globally unique IP addresses (i.e., WAN IP addresses) can be assigned to the client devices 26 on the internal network 10 so that the broadband router 22 does not need to perform address translation before forwarding packets to the external network 6 (from a client device 26) or to a client device 26 (from the external network). Thus, other embodiments of the router 22 can choose a particular communications link (i.e., service provider), by which to establish communications with an external network, independently of any network address translation. Yet another example, the invention can be practiced using IP addresses and IP protocols that extend beyond IPv6 (e.g., IPv7, IPV8, IPv16) and with non-IP protocols, non-IP addresses, and non-IP packets or datagrams.

What is claimed is:

1. A multi-homed router, comprising:
a first external-side port for exchanging packets over a first communication link with a first service provider connected to a communications network;
a second external-side port for exchanging packets over a second communication link with a second service provider connected to the communications network;
an internal-side port for exchanging packets with a client device connected to an internal network; and
means for determining which one of the service providers to use when establishing communications between the client device and a host system connected to the communications network.

2. The router of claim 1, wherein the first communication link is a cable line and the second communication link is a digital subscriber line (DSL).

3. The router of claim 1, further comprising a network address translator for performing address translation in packets exchanged between the client device and the communications network.

4. The router of claim 1, wherein the means for selecting selects one of the service providers based on a performance characteristic of each service provider.

5. The router of claim 1, wherein the means for selecting selects one of the service providers based on cost.

6. The router of claim 1, wherein the means for selecting selects one of the service providers based on a current load of each service provider.

7. The router of claim 1, further comprising means for determining when the communication link with one of the service providers fails, and further comprising means for contacting automatically that service provider with the failed communication link through the other service provider using the other communication link.

8. An internal network, comprising:
a client device transmitting a packet targeted to a host system on an external communications network; and
a router having an internal-side port by which to receive the packet from the client device, a first external-side port by which to communicate with a first service provider in order to access the external communications network, and a second external-side port by which to communicate with a second service provider in order to access the external communications network, the router having means for determining which one of the service providers to use in order to establish communications between the client device and the host system on the external communications network.

9. The internal network of claim 8, further comprising a cable modem connected to and through which the router communicates with one of the service providers, and a digital subscriber line (DSL) modem connected to and through which the router communicates with another of the service providers.

10. The internal network of claim 8, wherein the router includes a network address translator for performing address translation in the packet received from the client device before forwarding the packet to the selected service provider.

11. The internal network of claim 8, wherein the means for determining selects one of the service providers based on a performance characteristic of each service provider.

12. The internal network of claim 8, wherein the means for determining selects one of the service providers based on cost.

13. The internal network of claim 8, wherein the means for determining selects one of the service providers based on a current load of each service provider.

14. The internal network of claim 8, wherein the router further comprises means for determining that communications through one of the service providers fails and means for contacting automatically that service provider associated with the failed communications through the other service provider.

15. A method for exchanging packets between an internal network and an external communications network, the method comprising:
establishing a first communication link with a first service provider connected to the external communications network;
establishing a second communication link with a second service provider connected to the external communications network;
receiving, from a client device on the internal network, a packet targeted to a host system on the external communications network; and
determining which one of the first and second service providers to use for establishing communications between the client device and the host system on the external communications network.

16. The method of claim 15, further comprising performing address translation on the packet before forwarding the packet to one of the service providers.

17. The method of claim 15, wherein the step of determining includes selecting one of the service providers based on a performance characteristic of each service provider.

18. The method of claim 15, wherein the step of determining includes selecting one of the service providers based on cost.

19. The method of claim 15, wherein the step of determining includes selecting one of the service providers based on a current load of each service provider.

20. The method of claim 15, further comprising determining that the communication link to one of the service providers fails and contacting automatically that service provider associated with the failed communications through the other service provider.
